(19) United States
(12) Patent Application Publication
(10) Pub. No.: US 2003/0107521 A1
(43) Pub. Date: Jun. 12, 2003

(54) Room mirror with built-in antenna

(76) Inventors: Masaaki Matsuura, Shizuoka (JP); Hidenori Sato, Shizuoka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/220,299

(22) PCT Filed: Jan. 11, 2002
(86) PCT No.: PCT/JP02/00130

(30) Foreign Application Priority Data
May 15, 2001 (JP) 2001-145281

(51) Int. Cl. H01Q 1/32

(52) U.S. Cl. 343/713; 343/711

(57) ABSTRACT

A rearview mirror includes a stay 12, 35 fixed on and extending downward from a ceiling or a windshield 31 of a vehicle or fixed by a desorbable base 32 mounted on an adhesive portion 33 of the windshield 31, and a mirror body 11, 40 mounted at the bottom of the stay 12, 35 with its angle adjustable. The stay 12 or the base 32 has a recess portion 12a, 32a. The recess portion 12, 35 can be mounted later with one or more radio antenna units13a, 13b, 13c.

### FIELD OF THE INVENTION

The present invention relates to a rearview mirror with a built-in antenna, and more particularly, to a rearview mirror that has a radio antenna inside a stay or inside a base at a windshield adhesive portion.

### BACKGROUND ART

Radio signal devices in an automobile are increasing according to electronization and computerization of automobiles. Especially, a research on Intelligent Transport Systems (abbreviated as ITS) is developing; a road-to-car communication for communicating between the road and cars or car-to-car communication for communicating between the cars is being studied for practical use.

In the field of the navigational system equipped in vehicles, a system for providing real-time traffic information, what we call VICS (Vehicle Information and Communication System), has developed, and is in practical use as a radio beacon or an optical beacon. For another example, automatic toll collection transaction system, what we call ETC (Electronic Toll Collection system), is being studied for reducing traffic congestion near the tollgate.

Antennas for these radio communications must be fixed on the instrument panel in a vehicle and an adjustment must be made to its orientation. Especially, directivity of an ETC antenna is so high that stable communication is not available unless it is mounted to orient in a direction forming an upward angle of 20 degrees to a straight-ahead driving direction of the vehicle and parallel in a lateral direction.

If a communicating antenna is mounted on the instrument panel, however, mischief of a child or contact with something on the instrument panel may easily change the orientation of the antenna. Further, an antenna mounted in an instrument panel may have a problem in transmitting and receiving the radio signals if a baggage is placed on the antenna portion.

Thus, for the sake of resolving the problems of prior art, an object of the present invention is to provide an antenna device that stable communication is available and no adjustment of the orientation is required even if a contact or another accident is arisen after initial installation thereof.

### DISCLOSURE OF THE INVENTION

In order to achieve the above object, a rearview mirror with a built-in antenna of the present invention comprises: a stay fixed on and extending downward from a ceiling or a windshield of a vehicle or fixed by a base detachably mounted on an adhesive portion of the windshield; a mirror body mounted at the bottom of the stay with its- angle adjustable, wherein the stay or the base has a recess portion, and the recess portion can be mounted with one or more radio antenna units.

According to this construction, the rearview mirror does not obstruct driver's view and provides stable communication.

Moreover, as the stay of the present invention consists of metal material, the noise reduces and a directivity of the antenna rises.

Furthermore, because the recess portion has an angle-adjusting mechanism for adjusting a orientation of the radio antenna units, the antenna can be mounted in a sensitive direction. Also, covering an opening of the recess portion with an infrared transparent cover does not deface the rearview mirror.

The recess portion is provided with an antenna unit designed specifically for automatic toll collection transaction system and the mirror body is built in a dedicated in-vehicle device for automatic toll collection transaction system. According to this construction, production cost of the rearview mirror is reduced.

Moreover, painting on the recess portion to protect against scattering infrared radiation reduces incidence of a problem in transmitting and receiving the radio.

### BRIEF DESCRIPTION OF THE DRAWINGS

FIG. 1 is a perspective view of a rearview mirror with built-in antennas in accordance with a first embodiment of the invention;

FIG. 2 is an enlarged view of part A in FIG. 1;

FIG. 3 is an external view of the rearview mirror with built-in antennas in accordance with the first embodiment of the invention;

FIG. 4 is a block diagram showing a construction of the rearview mirror with built-in antennas in accordance with the first embodiment of the invention;

FIG. 5 is a sectional view showing a construction of the rearview mirror with built-in antennas in accordance with the first embodiment of the invention; and

FIG. 6 is an exploded view of FIG. 5.

### BEST MODE FOR CARRYING OUT THE INVENTION

With reference to the drawings, the first embodiment of the present invention is thereinafter described.

In the present embodiment, an example of a rearview mirror having an ETC in-vehicle device contained in a mirror body, and more than one antenna fixed in a stay, which includes a dedicated ETC antenna, is described.

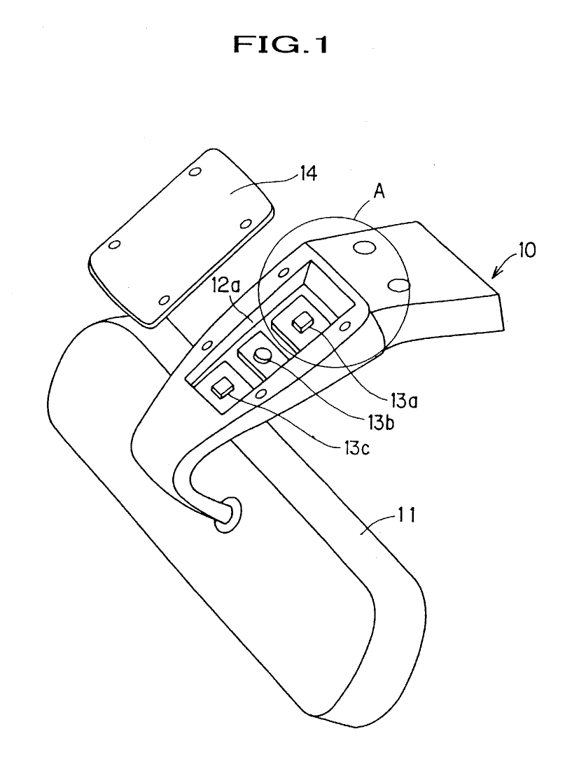

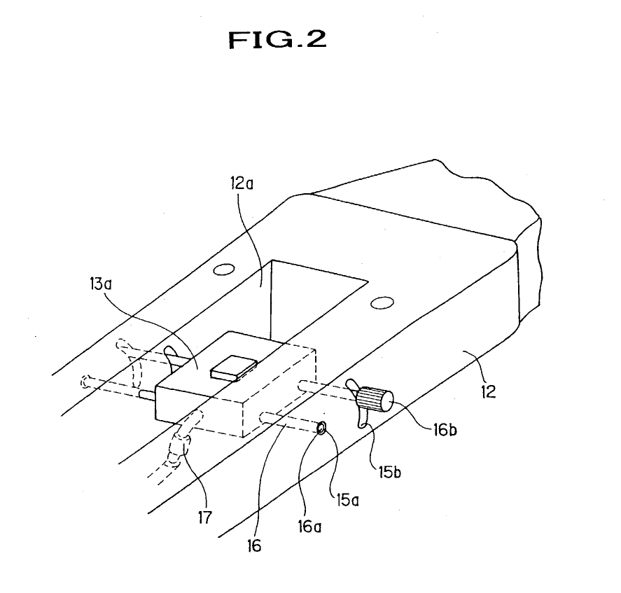

FIG. 1 is a perspective view of a rearview mirror with built-in antennas in accordance with a first embodiment of the invention; and FIG. 2 is an enlarged view of part A in FIG. 1.

As shown in FIG. 1, a rearview mirror 10 with built-in antennas in accordance with the present embodiment comprises a metal stay 12 fixed on a ceiling of the vehicle body and a mirror body 11 having an ETC in-vehicle device therein. Stay 12 is provided with a recess portion 12a, and antenna units 13a, 13b, 13c for radio communication such as ETC and VICS are provided inside this recess portion 12a.

Recess portion 12a provided in stay 12 is given a coat of paint to protect against scattering infrared radiation and is covered with a cover 14, which transmits radio wave such as infrared radiation and electric wave, for example acrylic acid resin, polypropylene, or polyethylene terephthalate so that the antenna units 13a, 13b, 13c can not externally be seen.

As shown in FIG. 2, stay 12 is provided with a fulcrum 15a and an arc hole 15b and is provided with a supporting screw 16a and two adjusting screws 16b, whose position is adjustable using a finger grip, so that the orientation of antenna unit 13 may be adjusted. Thus, even a high directive antenna such as a dedicated ETC antenna can be fixed at a position of good receiving conditions by adjusting the position using fulcrum 15a and arc hole 15b, and by fastening adjusting screw 16. Further, because only two screws 16 are used to fix antenna unit 13, any kind of antennas can be provided later if necessary.

Antenna units 13a, 13b, 13c are connected to an ETC in-vehicle device (not shown) in mirror body 11 by a harness that goes through inside stay 12.

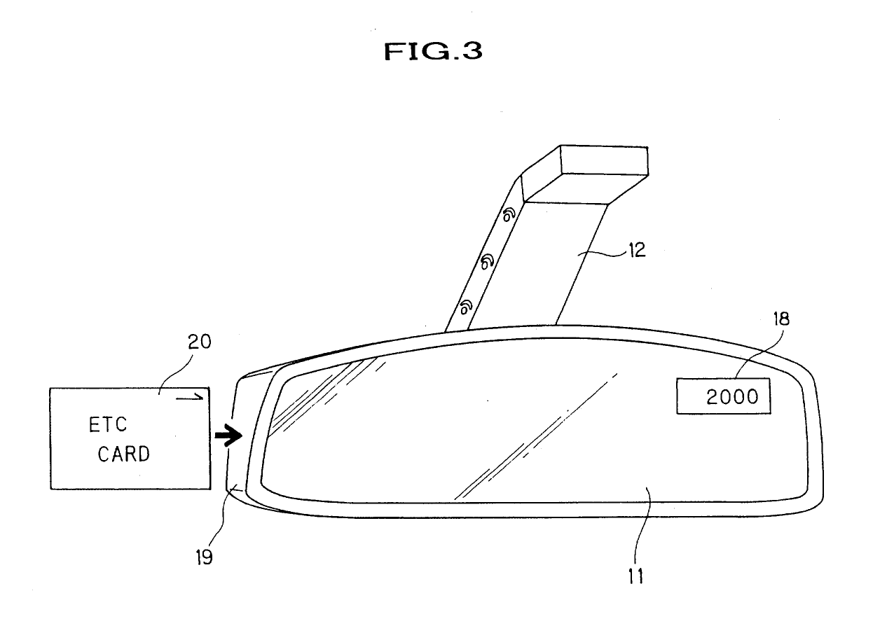

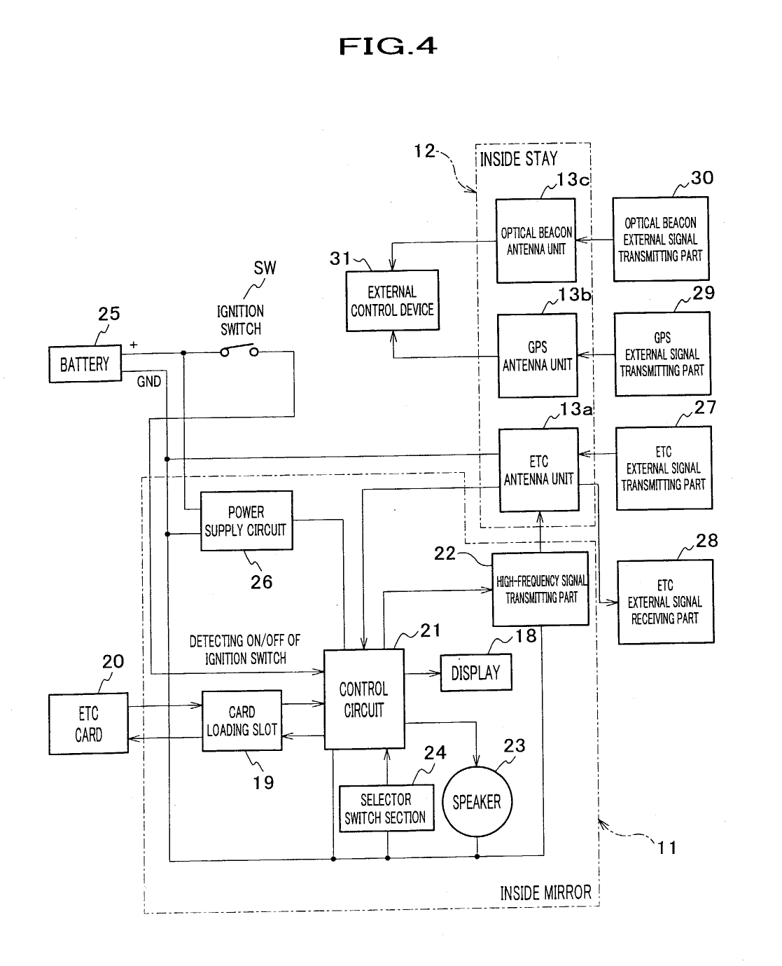

FIG. 3 is an external view of rearview mirror 10 with built-in antennas in accordance with the present embodiment; and FIG. 4 is a block diagram showing a construction of rearview mirror 10 with built-in antennas in FIG. 3. As shown in FIG. 3, mirror body 11 has the ETC in-vehicle device therein, so that mirror body 11 comprises a display 18 displaying ETC data such as balance data and billing data, and an ETC card-loading slot 19 for inserting an ETC card 20 for storing transmitted ETC data. Stay 12 of rearview mirror 10 with built-in antennas is provided with a dedicated ETC antenna unit 13a therein with antenna unit 13a fixed in a direction of 20 degree upward and parallel in right and left direction.

As shown in FIG. 4, stay 12 also includes a dedicated GPS (Global Positioning System) antenna unit 13b and optical beacon antenna unit 13c used only for optical beacon communication therein. GPS antenna unit 13b and optical beacon antenna unit 13c are designed to receive data signals respectively from the GPS and optical beacon external signal transmitting part 29, 30 and to output the data to an external control device 31 such as a car navigation system in the vehicle.

Moreover, mirror body 11 includes, as an ETC in-vehicle device, in addition to display 18 and card-loading slot 19, a control circuit 21 detecting an on/off state of an ignition switch SW and controlling communication with the ETC, a high-frequency signal transmitting part 22 transmitting a signal to an ETC external signal transmitting part 27, a speaker 23 announcing a caution of wrong operation by a sound, a selector switch section 24, and a power supply circuit 26 stabilizing voltage from a battery 25 mounted in the vehicle and supplying it to control circuit 21. Selector switch section 24 is a device giving a confirmative display of an accounting history (such as date and amount of money).

In paying a toll by ETC, antenna unit 13 mounted in the stay 12 of the vehicle communicates by radio with ETC external signal transmitting part 27 mounted at a head of tollbooth and ETC antenna unit 13a mounted in stay 12 of the vehicle communicates by radio with ETC external signal receiving part 28. ETC antenna unit 13a is placed in stay 12 of the rearview mirror, which is open to outside of the vehicle, to be free from noise and to communicate well with outside of the vehicle. Moreover, ETC antenna unit 13a is fixed at an optimum angle for ETC communication, and recess portion 12a is provided with cover 14 pervious to communicating radio so that the rearview mirror may provide stable communication without obstructing driver's view.

Recess portion 12a has three antenna units 13a, 13b, 13c for ETC, GPS, and optical beacon in the present embodiment, but the number of the antenna units may be one, two, or more than three and may be decided depending on setting space or systems according to driver's need. Cover 14 covers only recess portion 12a, but the section of the cover may be U-shaped to cover the screw 16 in order to have a good appearance. Further, the present invention is not limited to the above embodiment; mirror body 11 having the ETC in-vehicle device therein may be provided with numeric keypad for inputting a pin number.

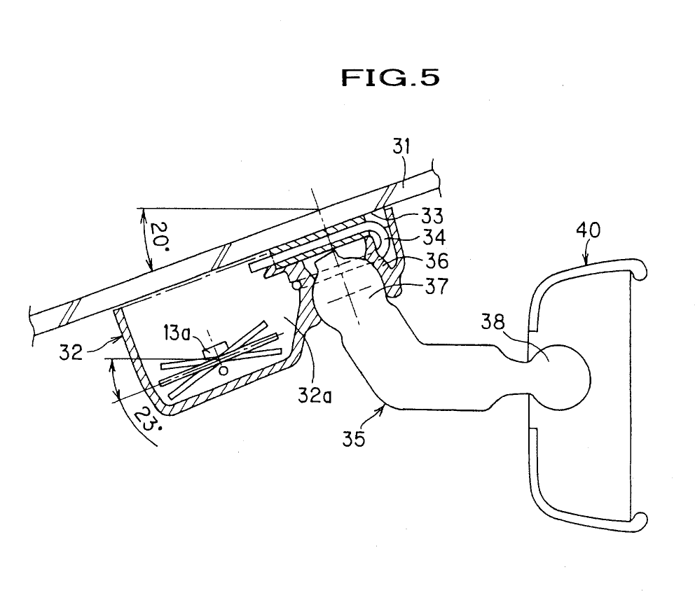

FIG. 5 is a sectional view showing a construction of the rearview mirror with built-in antennas in accordance with a second embodiment of the invention. As shown in FIG. 5, in the rearview mirror with built-in antennas of the present embodiment, a spring 34 is inserted into an adhesive portion 33, which is a metal piece glued on the inner surface of the windshield 31, to fix a base 32, and antenna unit 13a and other antennas are fitted inside a recess portion 32a of base 32. An upper pivot 37 of a stay 35 is fitted to a socket 36 formed adjacent to recess portion 32a while a lower pivot 38 is fitted to a socket (not shown) of a mirror body 40.

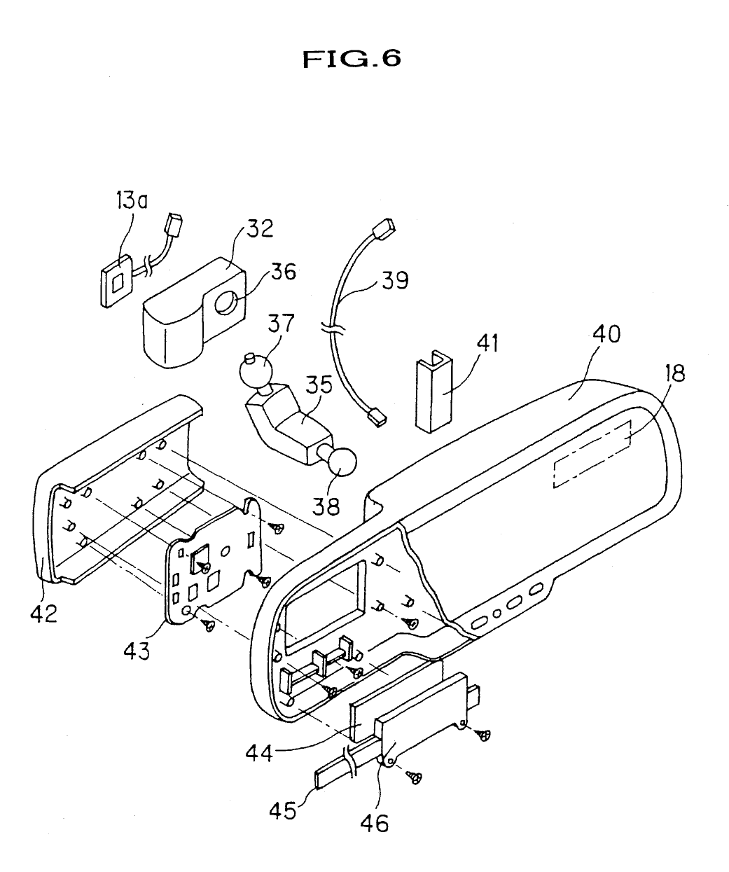

FIG. 6 is an exploded view of FIG. 5. In the drawing, 39 is a harness of a sub assembly; 41 is a cover for protecting harness 39; 42 is a card holder mounted behind mirror body 40; 43 is a control module including card-loading slot; 44 is a double-stick tape; 45 is a mirror-driving harness; and 46 is a transmitting module.

Since operation of the present embodiment is the same as that of the first embodiment, a description thereof will be omitted.

The rearview mirror with built-in antenna of the present invention, as described above, does not obstruct driver's view and provides stable communication as it has in a stay or a base a recess portion that can accommodate one or more radio antenna units. And the rearview mirror is protected from changing the orientation of the antenna by a mischief of children or the like.

In addition, as the stay consists of metal material, the noise coming from a direction against the antenna mounting face reduces and a directivity of the antenna rises.

Further, as the recess portion has the angle-adjustment mechanism for adjusting the orientation of the antenna unit, the antenna can be mounted in a direction of good receiving position. In addition, as an opening of the recess portion is covered with a cover of a material that is pervious to communicating radio wave and infrared radiation, the rearview mirror not only has good appearance but also prevents thefts.

As an antenna unit adaptable to the automatic toll collection transaction system is provided in the recess portion and a dedicated in-vehicle device for automatic toll collection transaction system is mounted in the mirror body, the harnesses between the in-vehicle device and the antenna can be shortened to reduce the production cost and noises.

Moreover, painting on the recess portion to protect against scattering infrared radiation reduces incidence rate of a problem in transmitting and receiving the radio.

1. A rearview mirror with a built-in antenna comprises:
a stay fixed on and extending downward from a ceiling or a windshield of a vehicle or fixed by a base detachably mounted on an adhesive portion of the windshield; and
a mirror body mounted at the bottom of the stay with its angle adjustable,
wherein said stay or said base has a recess portion in which one or more radio antenna units are mounted in such a manner that another radio antenna unit may be mounted later.

2. The rearview mirror with a built-in antenna according to claim 1,
wherein said stay consists of metal material.

3. The rearview mirror with a built-in antenna according to claim 1,
wherein said recess portion comprises an angle-adjustment mechanism for adjusting a orientation of said radio antenna units.

4. The rearview mirror with a built-in antenna according to claim 2,
wherein said recess portion comprises an angle-adjust mechanism for adjusting a orientation of said radio antenna units.

5. The rearview mirror with a built-in antenna according to claim 1,
wherein an opening of said recess portion is covered with a cover made of a material pervious to communicating radio wave and infrared radiation.

6. The rearview mirror with a built-in antenna according to claim 2,
wherein an opening of said recess portion is covered with a cover made of a material pervious to communicating radio wave and infrared radiation.

7. The rearview mirror with a built-in antenna according to claim 3,
wherein an opening of said recess portion is covered with a cover made of a material pervious to communicating radio wave and infrared radiation.

8. The rearview mirror with a built-in antenna according to claim 4,
wherein an opening of said recess portion is covered with a cover made of a material pervious to communicating radio wave and infrared radiation.

9. The rearview mirror with a built-in antenna according to claim 1,
wherein said recess portion is provided with an antenna unit adaptable to automatic toll collection transaction system and said mirror body is mounted with a dedicated in-vehicle device for automatic toll collection transaction system.

10. The rearview mirror with a built-in antenna according to claim 2,
wherein said recess portion is provided with an antenna unit adaptable to automatic toll collection transaction system and said mirror body is mounted with a dedicated in-vehicle device for automatic toll collection transaction system.

11. The rearview mirror with a built-in antenna according to claim 3,
wherein said recess portion is provided with an antenna unit adaptable to automatic toll collection transaction system and said mirror body is mounted with a dedicated in-vehicle device for automatic toll collection transaction system.

12. The rearview mirror with a built-in antenna according to claim 4,
wherein said recess portion is provided with an antenna unit adaptable to automatic toll collection transaction system and said mirror body is mounted with a dedicated in-vehicle device for automatic toll collection transaction system.

13. The rearview mirror with a built-in antenna according to claim 5,
wherein said recess portion is provided with an antenna unit adaptable to automatic toll collection transaction system and said mirror body is mounted with a dedicated in-vehicle device for automatic toll collection transaction system.

14. The rearview mirror with a built-in antenna according to claim 6,
wherein said recess portion is provided with an antenna unit adaptable to automatic toll collection transaction system and said mirror body is mounted with a dedicated in-vehicle device for automatic toll collection transaction system.

15. The rearview mirror with a built-in antenna according to claim 7,
wherein said recess portion is provided with an antenna unit adaptable to automatic toll collection transaction system and said mirror body is mounted with a dedicated in-vehicle device for automatic toll collection transaction system.

16. The rearview mirror with a built-in antenna according to claim 8,
wherein said recess portion is provided with an antenna unit adaptable to automatic toll collection transaction system and said mirror body is mounted with a dedicated in-vehicle device for automatic toll collection transaction system.

17. The rearview mirror with a built-in antenna according to any of claims 1-16,
wherein said recess portion is given a coat of paint to protect against scattering infrared radiation.
